(19) United States
(12) Patent Application Publication
(10) Pub. No.: US 2008/0012791 A1
(43) Pub. Date: Jan. 17, 2008

(54) LCD MONITOR AND METHOD FOR INSERTING BLACK FRAME

(75) Inventor: Tzong-Yau KU, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 11/776,086

(22) Filed: Jul. 11, 2007

(30) Foreign Application Priority Data
Jul. 12, 2006 (TW) 95125550

(51) Int. Cl. G09G 5/00

(52) U.S. Cl. 345/3.2

(57) ABSTRACT

An LCD monitor including M scan sections is provided for displaying one frame in one frame time. Each of the M scan section includes several scan lines. Each scan line corresponds to one pixel. A frame time includes M scan-section times corresponding to one of the M scan sections respectively. Each scan-section time includes one black-frame-inserting time and several scan-line times. All pixels corresponding to the (S+N)^{th} scan section is turned black during the black-frame-inserting time of the S^{th} scan section time. The scan lines in the S^{th} scan section are enabled during the scan-line times of the S^{th} scan-section time. S is an integer which is smaller or equal to M.

This application claims the benefit of Taiwan application Serial No. 95125550, filed Jul. 12, 2006, the subject matter of which is incorporated herein by reference.

### BACKGROUND OF THE INVENTION

1. Field of the Invention

The invention relates in general to a liquid crystal display (LCD), and more particularly to a liquid crystal display dividing a display region into several sections for inserting a black frame during a frame time when the LCD displays a frame.

2. Description of the Related Art

Recently as the optoelectronic technology and the semiconductor manufacturing technology has advanced, the flat panel displays have also developed rapidly. Liquid crystal display has the advantages including low voltage operation, no radiation, light weight and compact size. Therefore, LCD are rapidly replacing the conventional CRT (cathode ray tube) displays and are currently the most popular display in the market.

LCD mainly includes a liquid crystal display panel and a backlight module. The liquid crystal display panel is formed by a color filter substrate (C/F substrate), a thin film transistor (TFT) array substrate and a liquid crystal layer disposed between the two substrates. The backlight module is used for providing the liquid crystal display panel with a surface light source, so that the liquid crystal display is able to display frames. Furthermore, several pixel electrodes are disposed on the TFT array substrate. The rotation of the liquid crystal molecules is controlled by the pixel electrodes for determining the light quantity passing through the liquid crystal molecules.

When the human eyes focus on the moving frames displayed by the LCD, each frame stays on the screen for a while, and then the LCD displays the next frame. The motion of the object in the adjacent frames is discontinuous. When looking at a moving object, human eyes trace the positions of the object. When the LCD changes to the next frame, the surface light source is still provided by the backlight module. Therefore, human eyes can easily determine that the object does not move continuously when the screen changes the frames (that is, when the liquid crystal molecules rotate). Because the moving object in the adjacent frames is projected onto the retina in different positions, double image effect occurs and results in blurry outlines. As a result, the display quality of the LCD is affected greatly.

To solve the above problems, a black frame is inserted between two adjacent frames in the conventional LCD, such that human eyes are unable to sense the double image effect between frames.

However, the insertion of a black frame between two frames in the conventional LCD cuts the time that each pixel displays the frame in half. Also, each pixel is turned black during the other half time, which means the frame rate is doubled. As a result, the pixels can not be charged to the predetermined value because the time is too short. Some errors may therefore occur when the LCD displays the frames.

Another conventional solution is inserting a black frame during the blanking time of the frame time when the LCD scans a frame. FIG. 1 illustrates the frame time of the conventional LCD. In FIG. 1, the LCD includes 1024 scan lines, and the frame time TF includes 1066 line times. 1024 of the 1066 line times are scan-line times, and the other 42 line times are blanking times T_{blank}. Each scan line is enabled in one scan-line time. For example, when it is in the first scan-line time TS1, the first scan line is enabled. After all the 1024 scan-line times end, all the pixels of the LCD are turned black during the blanking time T_{blank}. In other words, after all the 1024 scan lines are enabled, all pixels are turned black. Therefore, the time that the 1024^{th} row of the pixels displays is the shortest, and the time that the first row of the pixels displays is the longest. The time that each row of the pixels displays is different. As a result, the lower part of the frame is darker than the upper part of the frame.

### SUMMARY OF THE INVENTION

The embodiments of the invention are directed to a method for driving a liquid crystal display (LCD). The LCD of the present invention inserts a black frame during a frame time when the LCD displays a frame. The double image effect of the moving frames is resolved effectively. The LCD of the present invention includes a display region divided into several scan sections. The blanking time is distributed to each scan section. All the pixels of one scan section are turned black within a predetermined scan time for inserting a black frame. The problem that the brightness of the upper portion of the frame is different from that of the lower portion is solved. The LCD of the present invention inserts a black frame without increasing the frame rate. However, any one who has ordinary skill in the field of the present invention can understand that the driving method of the present invention can also be combined with the technology to increase the frame rate.

According to one embodiment of the present invention, a liquid crystal display (LCD) is provided for displaying a frame in a frame time. The LCD includes M scan sections. Each scan section includes several scan lines, and each scan line is corresponding to a row of pixels. M is a positive integer. The frame time includes M scan-section times corresponding to the M scan sections. Each scan-section time of the scan section includes several line times. The line times includes a black-frame-inserting time and several scan-line times. During the black-frame-inserting time of a S^{th} scan-section time, the pixels corresponding to the scan lines of the (S+N)^{th} scan section are turned black. During the scan-line time of the S^{th} scan section time, the scan lines of the S^{th} scan section are enabled. S is a positive integer less than or equal to M. N is a positive integer less than or equal to M.

According to the present invention, a driving method is provided for a display. The display includes a display region divided into M scan sections. Each scan section includes several scan lines. The display region displays a frame in a frame time. The frame time is divided into M scan section times corresponding to M scan sections. Each scan section includes several line times. The line times include a black-frame-inserting time and several scan line times. The method includes following steps. First, the pixels corresponding to the scan lines of the (S+N)^{th} scan section are turned black. Next, during the scan line times of the S^{th} scan section period, the scan lines of the S^{th} scan section are enabled. M is a positive integer. S is a positive integer less than or equal to M. N is a positive integer less than or equal to M.

According to the present invention, a driving method is provided for driving a display by using frame data. The display includes a first scan section and a second scan section. The method includes following steps. First, the second scan section is turned black during a first black-frame-inserting time. Next, the first scan section is driven by using a first part of the frame data during a first scan section time. The first scan section is driven to black during a second black-frame-inserting time. Then, the second scan section is driven by using a second part of the frame data during a second scan section time.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) illustrates a frame time of a conventional liquid crystal display (LCD);

FIG. 2A shows the structure of a LCD according to a preferred embodiment of the present invention;

FIG. 2B illustrates the structure of the pixel 204 in FIG. 2A;

FIG. 3A illustrates scan sections of the LCD in FIG. 2A;

FIG. 3B illustrates a diagram of the frame time of the LCD in FIG. 3A when the LCD displays a frame;

FIG. 4A illustrates a diagram of time order of the frame time in FIG. 3B;

FIG. 4B illustrates a diagram of another time order of the frame time of the LCD in FIG. 3A; and

FIG. 5 is a flow chart of a driving method according to the preferred embodiment of the present invention.

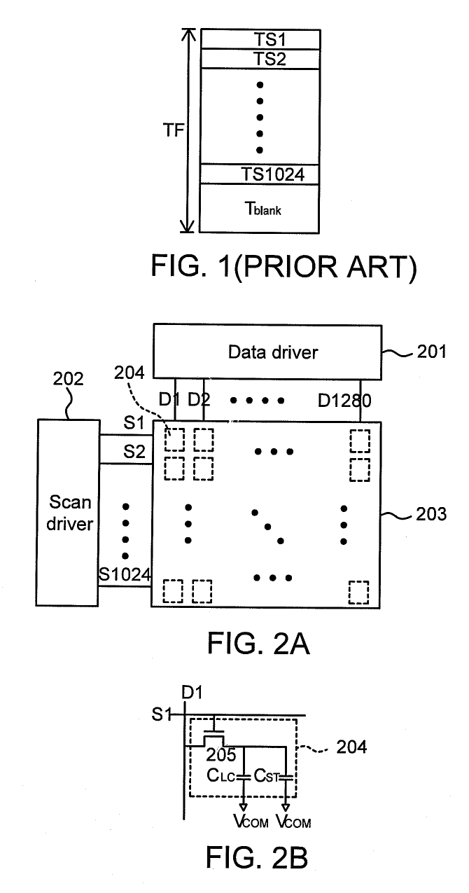

### DETAILED DESCRIPTION OF THE INVENTION

A liquid crystal display (LCD) of the present invention inserts a black frame during a frame time a frame displays for solving the double image effect associated with the moving frames. The LCD of the present invention includes a display region divided into several scan sections. Blanking time is distributed to each scan section. Each time all the pixels of one scan section are turned black for inserting the black frame. The LCD of the present invention inserts a black frame without increasing the frame rate.

FIG. 2A shows the structure of the LCD according to one embodiment of the present invention. Each pixel of a display panel 203 is controlled by a scan driver 202 through a scan line and receives data from a data driver 201 through a data line. For example, the pixel 204 of the display panel 203 is controlled by the scan driver 202 through the first scan line S1 and receives the data from the data driver 201 through the data line D1. The rest of the pixels of the display panel 203 are controlled and receive data similarly. The resolution of the preferred embodiment is 1280×1024 as an example. However, the present invention is not limited thereto.

FIG. 2B illustrates the structure of the pixel 204 in FIG. 2A. The pixel 204 includes a transistor 205, a liquid crystal capacitor C_{LC} and a storage capacitor C_{ST}. A gate of the transistor 205 is coupled with the first scan line S1. A drain of the transistor 205 is coupled with the data line D1. The liquid crystal capacitor C_{LC} and the storage capacitor C_{ST} are connected between a source of the transistor 205 and a common electrode V_{com}.

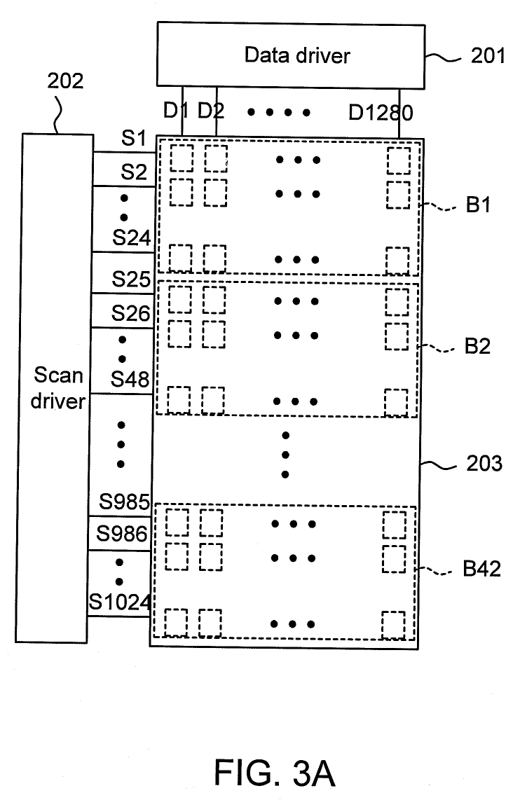

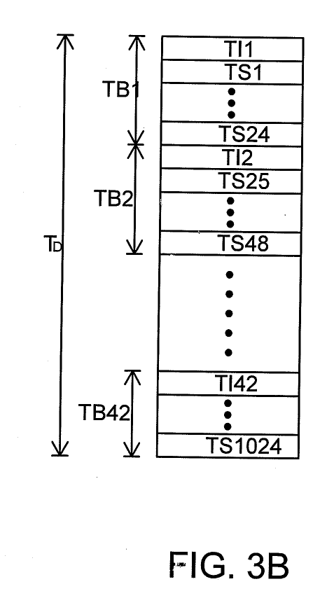

Please referring to FIG. 3A, different sections of the LCD in FIG. 2A are shown in FIG. 3A. The 1024 scan lines of the LCD in FIG. 2A are evenly distributed to 42 scan sections. Each scan section between the first scan section B1 to the 41^{st} scan section B41 has 24 (the integer portion of 1024/42) scan lines. The 42^{nd} scan section has 40 (1024−24×41=40) scan lines. For example, the first scan section B1 includes the first scan line S1 to the 24^{th} scan line S24. The 42^{nd} scan section B42 includes the 985^{th} scan line S985 to the 1024^{th} scan line S1024.

FIG. 3B illustrates the frame time of the LCD in FIG. 3A when the LCD displays a frame. Please referring to FIG. 3B, the LCD displays a frame during the frame time T_{D}. The frame time T_{D} includes 1024 scan-line times TS1˜TS1024 and a blanking time. Each scan line of the display is enabled during one scan-line time. As shown in FIG. 3B, the blanking time is divided into 42 black-frame-inserting times TB1˜TB42 respectively corresponding to the 42 scan line sections B1˜B42. The 1024 scan-line times and the 42 black-frame-inserting times are evenly distributed to the 42 scan-section times. As a result, each time period between the first scan-section time TB1 to the 41^{st} scan-section line period TB41 includes a black-frame-inserting time and 24 (the integer portion of 1024/42) scan-line times. The 42^{nd} scan-section time TB42 includes a black-frame-inserting time and 40 (1024−24×41=40) scan-line times. The length of each scan-line time is the same as that of each black-frame-inserting time. The 24 scan lines of the first scan section B1 to the 41^{st} scan section B41 are enabled during the first scan-section time TB1 to the 41^{st} scan-section time TB41 respectively. The 40 scan lines of the 42^{nd} scan section B42 are enabled during the 42^{nd} scan-section time TB42. The first line time of each scan-section time is the black-frame-inserting time in the present embodiment. However, the black-frame-inserting time can be located in any position during the scan-section time.

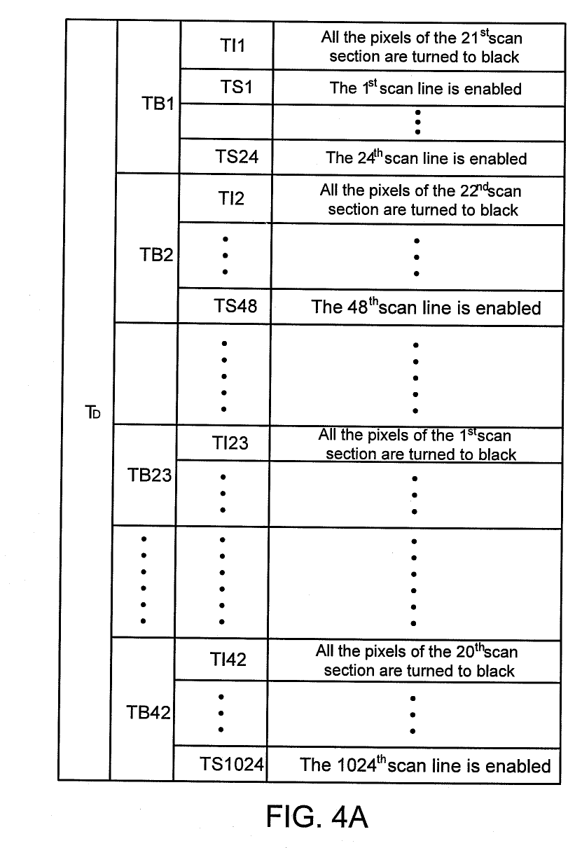

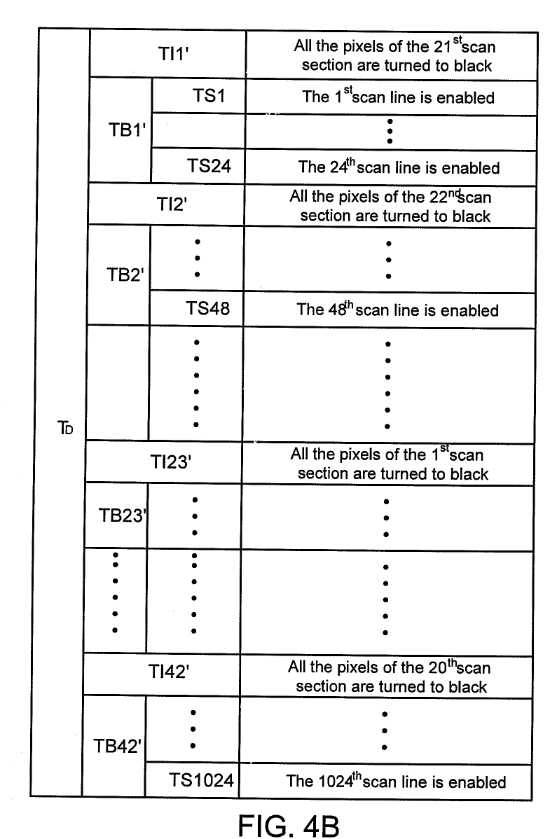

All the pixels of the 21^{st} scan section are turned black first in the present embodiment as an example to illustrate the method for inserting a black frame according to the present embodiment. FIG. 4A illustrates time order of the frame time in FIG. 3B. First, during the black-frame-inserting time TI1 of the first scan-section time TB1, the pixels corresponding to all the scan lines of the 21^{st} scan section B21 are turned black. Next, during the first scan-line period TS1 of the first scan-section time TB1, the first scan line S1 is enabled. During the second scan-line time TS2 of the first scan-section time TB1, the second scan line S2 is enabled. Then, other scan lines of the first scan section B1 are enabled during the first scan-section time TB1 similarly. Afterwards, during the black-frame-inserting time TI2 of the second scan-section time TB2, all the pixels corresponding to the scan lines of the 22^{nd} scan section B22 are turned black. Later, the above steps are repeated during the second scan-section time TB2 and not described to avoid redundancy.

During the black-frame-inserting time TI22 of the 22^{nd} scan-section time TB22, all the pixels corresponding to the scan lines of the 42^{nd} scan-section B42 are turned black. Thereon, during the black-frame-inserting time TI23 of the 23^{rd} scan-section time TB23, all the pixels corresponding to the scan lines of the first scan section B1 are turned black. During the black-frame-inserting time TI24 of the 24^{th} scan-section time TB24, all the pixels corresponding to the scan lines of the second scan section B2 are turned black. The following steps during the rest of the black-frame-inserting times are similar to the above ones.

In another embodiment, 24 scan lines are in the first scan section to the 26^{th} scan section. 25 scan lines are in the 27^{th} scan section to the 42^{nd} scan section. Each scan-section time of the first scan-section time to the 26th scan-section time includes 24 scan-line times. Each scan-section time of the 27^{th} scan-section time to the 42^{nd} scan-section time includes 25 scan-line times.

The scan-line times are distributed to all the scan-section times evenly in the embodiment of the present invention. Therefore, all the scan lines in each scan section between the first scan section B1 to the 41^{st} section B41 have the same enabling time. The conventional problem that the enabling time of each scan line is different is resolved, and all the portions of the frame have the same brightness.

In the present embodiment, all the scan lines of the 21^{st} scan section B21 are turned black first as an example. However, pixels in any scan section can be turned black first. For example, in another embodiment, the pixels corresponding to the scan lines in the 11^{th} scan section B11 are turned black first. In other words, during the black-frame-inserting time TI1 of the first scan section time, the pixels corresponding to the scan lines in the 11^{th} scan section B11 are turned black. The actions in the rest of the black-frame-inserting time are similar as those above. The steps of inserting other black frames are similar to those above. In FIG. 4A which shows the time order of the frame time, the black-frame-inserting time of each scan-section time is the first line time of each scan-section time. However, the black-frame-inserting time can be located in any position within each scan-section time.

FIG. 4B illustrates another time order of the frame time of the LCD in FIG. 3A. The LCD displays a frame in a frame time T_{D}. The frame time T_{D} includes 1024 scan-line times TS1˜TS1024 and a blanking time. The 1024 scan-line times TS1˜TS1024 are divided into 42 scan-section times, which respectively correspond to the 42 scan sections B1˜B42 of the display. There is a black-frame-inserting time before each scan-section time. As a result, each scan-section time between the first scan-section time TB1′ to the 41^{st} scan-section time TB41′ has 24 (the integer portion of 1024/42) scan-line times. The 42^{nd} scan-section time TB42′ includes 40 (1024−24×41=40) scan-line times. The first black-frame-inserting time TI1′ is before the first scan-section time TB1′. The second black-frame-inserting time TI2′ is before the second scan-section time TB2′. The rest of the black-frame-inserting times are located similarly.

In FIG. 4B, firstly, during the first black-frame-inserting time TI1′, the pixels corresponding to all the scan lines of the 21^{st} scan section B21 are turned black. Next, during the first scan-line time TS1 of the first scan-section time TB1′, the first scan line of the LCD is enabled. During the second scan-line time TS2 of the first scan-section time TB1′, the second scan line S2 is enabled. Afterwards, the steps during the first scan-section time TB1′ are similar to above ones. Thereon, during the second black-frame-inserting time TI2′, the pixels corresponding to all the scan lines of the 22^{nd} scan section B22 are turned black. Later, the steps during the second scan-section time TB2′ are similar to those in the first scan-section time TB1′ and not described redundantly.

During the 22^{nd} black-frame-inserting time TI22′, the pixels corresponding to all the scan lines of the 42^{nd} scan section B42 are turned black. Then, during the 23^{rd} black-frame-inserting time TI23′, the pixels corresponding to all the scan lines of the first scan section B1 are turned black. During the 24^{th} black-frame-inserting time TI24′, the pixels corresponding to all the scan lines of the second scan section B2 are turned black. Subsequently, the steps during the other black-frame-inserting times are similar to above ones.

In FIG. 4B, each black-frame-inserting time is located before one scan-section time as an example. However, each black-frame-inserting time can be located after one scan-section time. Furthermore, the pixels corresponding to all the scan lines of the 21^{st} scan section B21 are turned black first as an example in the present embodiment. However, the pixels corresponding to any scan section can be turned black first. For example, in another embodiment, the pixels corresponding to all the scan lines of the 11^{th} scan section B11 are turned black first. During the first black-frame-inserting time, all the pixels corresponding to the scan lines of the 11^{th} scan section are turned black. The steps during other black-frame-inserting times are similar to above ones.

The LCD of the present invention is a normally white LCD or a normally black LCD. The LCD includes a scan driver for driving the scan lines of the scan sections. The scan driver includes a first shift register and a second shift register. The first shift register is for controlling the black-frame-inserting times. The second shift register is for controlling the scan-line times. The number of the scan lines in each scan section is not necessarily the same.

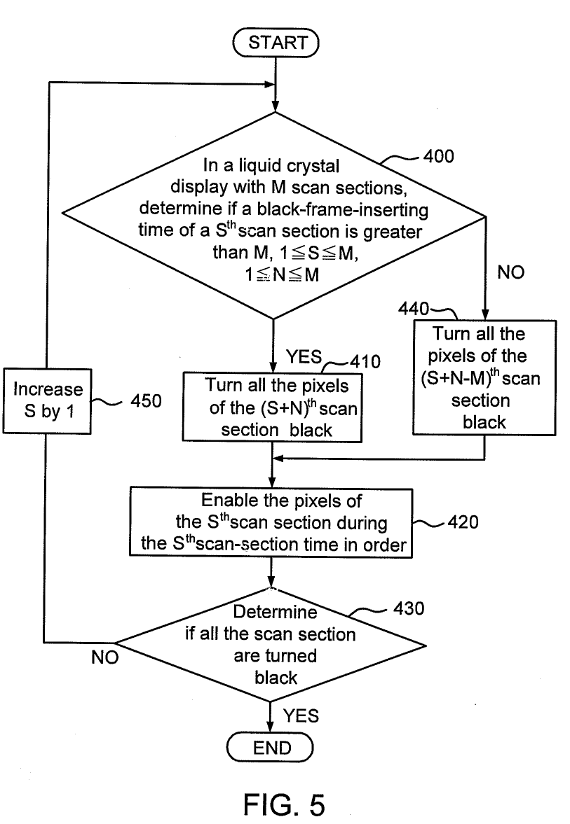

FIG. 5 is a flow chart of a driving method according to the embodiment of the present invention. The driving method of the present invention is for a LCD. The LCD includes a display region divided into M scan sections. Each scan section includes several scan lines. The display region displays a frame in a frame time. The frame time is divided into several scan-section times corresponding to the scan sections. Each scan-section time includes a black-frame-inserting time and several scan-line times. First, in step 400, during the black-frame-inserting time of the S^{th} scan-section time, determine whether (S+N) is greater than M. N is an integer between 1 and M. When it is false, then the method goes to a step 410. When it is true, then the method goes to a step 440. In step 410, the pixels corresponding to all the scan lines of the (S+N)^{th} scan section are turned black. In the step 440, all the pixels of the (S+N-M)^{th} scan section are turned black. Next, in step 420, during the scan-line time of the S^{th} scan section time, enable the scan lines of the S^{th} scan section in order. In step 430, it is determined whether the pixels of all the scan sections are all turned black already. When it is true, the method ends. When it is false, the method goes to step 450. In step 450, S is increased by 1. In other words, the above steps are repeated in the next scan-section time until all the pixels of the scan sections are turned black.

For example, in the above mentioned flow chart, M is equal to 42, and N is equal to 20. During the first scan-section time (that is, S is equal to 1), the step 400 is false. Therefore, during the black-frame-inserting time of the first scan-section time, the pixels corresponding to all the scan lines in the 21^{st} scan section are turned black. During the scan-line times of the first scan-section time, the scan lines of the first scan section are enabled. During the 23^{rd} scan-section time, the step 400 is true. In other words, the 21^{st} to the 42^{nd} scan section are turned black already. The first 20 scan sections are needed to be turned black. Therefore, during the black-frame-inserting time of the 23^{rd} scan-section time, the pixels corresponding to all the scan lines of the first scan section are turned black.

The black-frame-inserting time is the first line time of each scan-section time. However, the black-frame-inserting time can be located in any position within each scan-section time.

A black frame is inserted during the blanking time of the frame time when the LCD displays a frame. The display region of the LCD is divided into several scan sections. The blanking time is distributed to each scan section evenly. Each time the pixels in one scan section are turned black for inserting the black frame without increasing the frame rate. The problem of the conventional LCD that the lower portion of the frame is darker than the upper portion is resolved.

While the invention has been described by way of example and in terms of an embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display (LCD) for displaying a frame in a frame time, the LCD comprising:
M scan sections, each of the scan sections comprising a plurality of scan lines, each of the scan lines corresponding to a row of pixels, M being a positive integer;
wherein the frame time comprises M scan-section times corresponding to the M scan sections respectively, each of the scan-section times comprising a plurality of line times, the line times comprising a black-frame-inserting time and a plurality of scan-line times, during the black-frame-inserting time of the S^{th} scan-section time of the scan-section times, the pixels corresponding to the scan lines of the (S+N)^{th} scan section of the scan-section being turned black, during the scan-line times of the S^{th} scan section, the scan lines of the S^{th} scan section being enabled; S being a positive integer less than or equal to M, N being a positive integer less than or equal to M.

2. The LCD according to claim 1, wherein the pixels corresponding to the scan lines of the (S+N-M)^{th} scan section of the scan section are turned black during the black-frame-inserting time of the S^{th} scan section time, (S+N) greater than M.

3. The LCD according to claim 1, wherein the f^{th} line time within the line times is the black-frame-inserting time, f being a positive integer.

4. The LCD according to claim 1, wherein the length of the line times in each scan section time is substantially the same.

5. The LCD according to claim 1, wherein the LCD is a normally white LCD or a normally black LCD.

6. The LCD according to claim 1, wherein each of the black-frame-inserting times is part of a blanking time.

7. The LCD according to claim 1, wherein the number of the scan lines of each scan section is substantially the same.

8. The LCD according to claim 1, wherein the number of the scan lines of each scan section is different.

9. The LCD according to claim 1 further comprising a scan driver for driving the scan lines of the scan sections, the scan driver comprising:
a first shift register for controlling the black-frame-inserting times; and
a second shift register for controlling the scan-line times.

10. The LCD according to claim 1, wherein M is greater than or equal to 2.

11. A method for driving a display, the display comprising a display region divided into M scan sections, each of the scan sections comprising a plurality of scan lines, the display region displaying a frame in a frame time, the frame time being divided into M scan section times corresponding to the M scan sections, each scan-section time comprising a plurality of line times, the line times comprising a black-frame-inserting time and a plurality of scan-line times, the method comprising:
turning the pixels corresponding to all the scan lines of the (S+N)^{th} scan section black during the black-frame-inserting time of the S^{th} scan-section time; and
enabling the scan lines of the S^{th} scan section in the scan-line times of the S^{th} scan-section time;
wherein M is a positive integer, S and N are positive integers less than or equal to M.

12. The method according to claim 11, further comprising:
turning the pixels corresponding to the scan lines of the (S+N−M)^{th} scan section during the black-frame-inserting time of the S^{th} scan section time when (S+N) is greater than M.

13. The method according to claim 11, wherein the f^{th} line time is the black-frame-inserting time, f being a positive integer.

14. The method according to claim 11, wherein the length of the line times of each scan-section time is substantially the same.

15. The method according to claim 11, wherein the display is a normally white LCD or a normally black LCD.

16. The method according to claim 11, wherein each black-frame-inserting time is part of a blanking time.

17. The method according to claim 11, wherein the number of the scan lines of each scan section is substantially the same.

18. The method according to claim 11, wherein the number of the scan lines of each scan section is different.

19. The method according to claim 11, wherein the display comprises a scan driver for driving the scan lines of the scan sections, the scan driver comprising:
a first shift register for controlling the black-frame-inserting times; and
a second shift register for controlling the scan line times.

20. The method according to claim 11, wherein M is greater than or equal to 2.

21. A method for driving a display by using frame data, the display comprising a first scan section and a second scan section, the driving method comprising:
turning the second scan section black during a first black-frame-inserting time;
driving the first scan section by using a first part of the frame data during a first scan-section time;
driving the first scan section black during a second black-frame-inserting time; and
driving the second scan section by using a second part of the frame data during a second scan-section time.

22. The method according to claim 21, wherein the time that the first scan section displays the first part of the frame data is substantially equal to the time that the second scan section displays the second part of the frame data.

23. The method according to claim 21, wherein the display is a normally white liquid crystal display (LCD) or a normally black LCD.

24. The method according to claim 21, wherein the first black-frame-inserting time and the second black-frame-inserting time are part of a blanking time.

25. The method according to claim 21, wherein the number of the scan lines of the first scan section is substantially the same as that of the second scan section.

26. The method according to claim 21, wherein the number of the scan lines of the first scan section is different from that of the second scan section.

27. The method according to claim 21, wherein the display comprises a scan driver for driving the scan lines of the first scan section and the second scan section, the scan driver comprising:
a first shift register for controlling the first black-frame-inserting time and the second black-frame-inserting time: and
a second shift register for controlling the first scan-section time and the second scan-section time.
